(19) United States
(12) Patent Application Publication
(10) Pub. No.: US 2013/0037054 A1
(43) Pub. Date: Feb. 14, 2013

(54) METHOD FOR PRODUCING IMAGING LENS

(71) Applicant: Nobuhiro Saruya, Hino-shi (JP)

(72) Inventor: Nobuhiro Saruya, Hino-shi (JP)

(21) Appl. No.: 13/643,477

(22) PCT Filed: Apr. 4, 2011
(86) PCT No.: PCT/JP2011/058500

§ 371 Date: Oct. 25, 2012

(30) Foreign Application Priority Data
Apr. 28, 2010 (JP) 2010-103437

(51) Int. Cl. B08B 7/00

(52) U.S. Cl. 134/7

(57) ABSTRACT

Disclosed is a method for producing an imaging lens in which a plurality of layers including one or more wafer lenses each provided with a lens portion that is formed from a curable resin are laminated on at least one surface of a substrate. The method for producing an imaging lens comprises, before lamination of the plurality of layers including the wafer lenses, a first lens portion cleaning step wherein carbon dioxide cleaning of the lens portions is carried out by spouting carbon dioxide so as to form dry ice particles and by causing the dry ice particles to hit on the lens portions of the wafer lenses or the vicinities of the lens portions. Consequently, deterioration of optical performance, changes in optical performance due to moisture absorption, and separation of the resin from the substrate can be prevented.

### TECHNICAL FIELD

The present invention relates to a method for producing an imaging lens,

### BACKGROUND ART

Conventionally, in the field of producing an optical lens, a technique being considered is to obtain an optical lens with high heat resistance by providing a lens portion formed from a curable resin, on a glass substrate (for example, see Patent Document 1). As an example of a producing method of an optical lens applying the above technique, there is proposed a method to form what is called a “wafer lens” in which a plurality of optical members made from a curable resin are provided on a surface of a glass substrate and then the glass substrate is cut for each lens portion.

Such wafer lens is outstanding in that a large amount of small optical systems of an imaging apparatus such as a camera for a cellular telephone can be collectively made, however there are also technical problems.

That is, lately, even in cameras for cellular telephones, there is a trend of the resolution becoming higher and the number of lenses increasing. Therefore, when the wafer lens is used in such imaging lens of the imaging apparatus, there is a need to use a wafer lens laminated body where a plurality of wafer lenses and spacers are laminated, instead of a wafer lens formed with a lens portion on a single glass substrate.

### PRIOR ART DOCUMENT

### Patent Document

Patent Document 1: Japanese Patent No. 3926380

### DISCLOSURE OF THE INVENTION

### Problems to be Solved by the Invention

When such wafer lens laminated body is produced, dust may be attached to the wafer lens or the spacer. When wafer lenses or spacers with dust attached are used as is and a plurality of wafer lenses are laminated or a spacer is bonded after lamination, the interval of the lens changes and there is a problem that the optical performance deteriorates.

Therefore, it is necessary to perform cleaning processing before lamination of the wafer lens or before the bonding of the spacer. However, there is the problem that since the lenses are made from resin, cleaning by water changes the optical performance due to water absorption and moisture absorption. That is, when a laminated body of the wafer lens is used, moisture develops in the laminated layers after lamination of the wafer lens due to water absorption and moisture absorption when each wafer lens is cleaned, and this causes the lens to be fogged. In actual use, it is not possible to clean with only pure water and therefore a cleaning agent, etc. is used for cleaning. However, the cleaning agent may remain in the laminated portion and this may worsen the lens interval. Further, ultrasonic waves may be used as the cleaning processing. However, in this case there is a possibility that separation of the resin from the substrate occurs, which is not preferable.

The present invention is conceived in view of the above conditions, and the object is to provide a method for producing an imaging lens which can reliably and easily remove dust to prevent deterioration of optical performance, changes in optical performance due to moisture absorption, and separation of the resin from the substrate.

### Means for Solving the Problem

According to one aspect of the present invention, there is provided a method for producing an imaging lens in which a plurality of layers including one or more wafer lenses each provided with a lens portion that is formed from a curable resin are laminated on at least one surface of a substrate, the method including:

before lamination of the plurality of layers including the wafer lenses, a first lens portion cleaning step wherein carbon dioxide cleaning of the lens portions is carried out by spouting carbon dioxide so as to form dry ice particles and by causing the dry ice particles to hit on the lens portions of the wafer lenses or the vicinities of the lens portions.

Here, from the viewpoint of removing dust reliably and easily and preventing deterioration of optical performance, it is necessary to clean an imaging element laminated to the wafer lens and a spacer to bond the lenses to each other or to bond between the lens and the imaging element. Therefore, the plurality of layers include the spacer and the imaging element other than the wafer lens.

### Advantageous Effect of the Invention

According to the present invention, it is possible to reliably and easily remove dust and to prevent deterioration of optical performance. Moreover, it is possible to prevent changes in optical performance due to moisture absorption and separation of the resin from the substrate.

### BRIEF DESCRIPTION OF THE DRAWINGS

FIG. 1 is a cross sectional diagram showing a schematic configuration of an imaging apparatus and an imaging lens used in the imaging apparatus;

FIG. 2 is a diagram schematically describing when a wafer lens laminated body produced in an imaging lens producing process is cut;

FIG. 3 is a process diagram describing a method for producing the imaging lens;

FIG. 4 is a schematic diagram of a carbon dioxide cleaning apparatus;

FIG. 5A is a planar diagram showing a lens portion and a nozzle for describing the method for producing the imaging lens, specifically carbon dioxide cleaning;

FIG. 5B is a planar diagram showing a lens portion and a nozzle for describing the method for producing the imaging lens, specifically carbon dioxide cleaning;

FIG. 6A is a modification of FIG. 5A and FIG. 5B;

FIG. 6B is a modification of FIG. 5A and FIG. 5B;

FIG. 7 is a modification of FIG. 1, and is a cross sectional diagram showing a schematic configuration of an imaging apparatus and an imaging lens used in the imaging apparatus; and

FIG. 8 is a modification of FIG. 2, and is a diagram schematically describing when a wafer lens laminated body produced in an imaging lens producing process is cut.

### EMBODIMENT FOR CARRYING OUT THE INVENTION

The preferred embodiment of the present invention is described with reference to the drawings.

### [Imaging Apparatus]

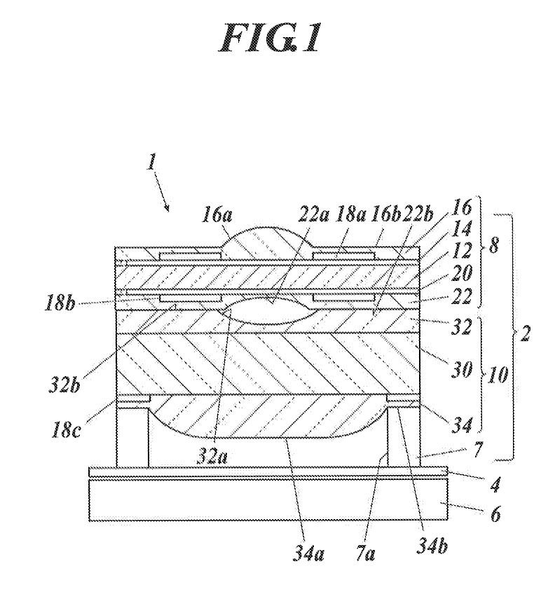

As shown in FIG. 1, the imaging apparatus 1 includes an imaging lens 2, a cover glass 4 of the imaging element, an imaging element 6, and the like. The cover glass 4 and the imaging element 6 are provided below the imaging lens For example, a CMOS type image sensor is used as the imaging element 6

The imaging lens 2 includes two groups of lens groups 8 and 10 and a spacer 7.

The lens group 8 includes a glass substrate 12.

A resin portion 16 is formed on an upper surface of the glass substrate 12. An aperture 18a is formed between the glass substrate 12 and the resin portion 16. The resin portion 16 includes a convex lens portion 16a and a non-lens portion 16b within the vicinity of the convex lens portion 16a. The convex lens portion 16a and the non-lens portion 16b are formed as one. The convex lens portion 16a has a surface with an aspheric shape. The aperture 18a is covered by the non-lens portion 16b.

A resin portion. 22 is formed on a lower surface of the glass substrate 12. An aperture 18b is formed between the glass substrate 12 and the resin portion 22. The resin portion 22 includes a concave lens portion 22a and a non-lens portion 22b within the vicinity of the concave lens portion 22a. The concave lens portion 22a and the non-lens section 22b are formed as one. The concave lens portion 22a has a surface with an aspheric shape. The aperture 18b is covered with a non-lens portion 22b.

The lens group 8 includes a glass substrate 12, resin portions 16 and 22, and apertures 18a and 18b.

The lens group 10 includes a glass substrate 30.

A resin portion 32 is formed on an upper surface of the glass substrate 30. The resin portion 32 includes a convex lens portion 32a and a non-lens portion 32b within the vicinity of the convex lens portion 32a. The convex lens portion 32a and the non-lens portion 32b are formed as one. The convex lens portion 32a has a surface with an aspheric shape.

A resin portion 34 is formed on a lower surface of the glass substrate 30. An aperture 18c is formed between the glass substrate 30 and the resin portion 34. The resin portion 34 includes a concave lens portion 34a and a non lens portion 34h within the vicinity of the concave lens portion 34a. The concave lens portion 34a and the non-lens section 34b are formed as one. The concave lens portion 34a has a surface with an aspheric shape. The aperture 18c is covered with a non-lens portion 34b.

The lens group 10 includes a glass substrate 30, resin portions 32 and 34, and aperture 18c,

The resin portions 16 and 22 of the lens group 8 and the resin portions 32 and 34 of the lens group 10 are formed from photo-curable resin.

As the photo-curable resin, it is possible to use resin described below such as acrylic resin, allylic ester resin, epoxy type resin. Specifically, epoxy resin is effective for the present invention in the point that the transfer accuracy of the surface shape is preferable.

When the acrylic resin or the allylic ester resin is used, it is possible to react and cure by radical polymerization and when the epoxy resin is used, it is possible to react and cure by cationic polymerization.

The type of resin composing each portion of the lens groups 8 and 10 can be the same as each other or different from each other.

The details of the resin are described in items (1) to (3) below.

### (1) Acrylic Resin

Methacrylate used in the polymerization reaction is not particularly limited, and the methacrylate described below produced by typical producing methods can be used. There are ester methacrylate, urethane methacrylate, epoxy methacrylate, ether methacrylate, alkyl methacrylate, alkylene methacrylate, methacrylate including aromatic ring, and methacrylate including alicyclic structure. One type or two types or more of the above can be used.

Specifically, it is preferable to use a methacrylate with an alicyclic structure and an alicyclic structure including an oxygen atom or a nitrogen atom can be used. For example, there are cyclohexyl methacrylate, cyclopentyl methacrylate, cycloheptyl methacrylate, bicylcoheptyl methacrylate, tricyclodecyl methacrylate, tricyclodecanedimethanol methacrylate, isobornyl methacrylate, hydrogenated bisphenol dimethacrylate or the like. Specifically, it is preferable to include an adamantane skeleton. For example, there are 2-alkyl-2-adamantyl methacrylate (see Japanese Patent Application Laid-Open Publication No. 2002-193883), adamantyl dimethacrylate (see Japanese Patent Application Laid-Open Publication No. S57-500785), adamantyl dicarboxylic acid diallyl (see Japanese Patent Application Laid-Open Publication No. 560-100537), perfluroroadamantyl acrylic acid esther (see Japanese Patent Application Laid-Open Publication No. 2004-123687), manufactured by Shin-Nakamura Chemical Co., Ltd., 2-methyl-2-adamantyl methacrylate, 1,3-adamantane diol diacrylate, 1,3,5-admantane triol triacrylate, undersaturation carboxylic adamantyl esther (see Japanese Patent Application Laid-Open Publication No. 2000-119220), 3,3′-dialkoxycarbonyl-1,1′ biadamantane (see Japanese Patent Application Laid-Open Publication No. 2001-253835), 1,1′-biadamantane compound (see specification of U.S. Pat. No. 3,342,880), tetraadamantane (see Japanese Patent Application Laid-Open Publication No. 2006-169177), curable resin including the adamantane skeleton not including an aromatic ring such as, 2-alkyl-2-hydroxyadamantane, 2-alkylene adamantane, 1,3-adamantane dicarboxylate di-tert-butyl (see Japanese Patent Application Laid-Open Publication No. 2001-322950), bis(hydroxyphenyl)adamantane type, bis(glycidyloxyphenyl)adamantane (see Japanese Patent Application Laid-Open Publication No. H11-35522, Japanese Patent Application Laid-Open Publication No. H10-130371).

Other reactive monomer may be included. As methacrylate, there are for example, methyl acrylate, methyl methacrylate, n-butyl acrylate, n-butyl methacrylate, 2-ethylhexyl acrylate, 2-ethylhexyl methacrylate, isobutyl acrylate, isobutyl methacrylate, tert-butyl acrylate, tert-butyl methacrylate, phenyl acrylate, phenyl methacrylate, benzyl acrylate, benzyl methacrylate, cyclohexyl acrylate, cyclohexyl methacrylate, or the like.

As multifunctional methacrylate, there are for example, trimethylolpropane trimethacrylate, pentaerythritol tetramethacrylate, pentaerythritol trimethacrylate, dipentaerythritol hexamethacrylate, dipentaerythritol pentamethacrylate, dipentaerythritol tetramethacrylate, dipentaerythritol trimethacrylate, tripentaerythritol octamethacrylate, tripentaerythritol septamethacrylate, tripentaerythritol hexamethacrylate, tripentaerythritol pentamethacrylate, tripentaerythritol tetramethacrylate, tripentaerythritol trimethacrylate, or the like.

### (2) Allylic Ester Resin

As resin which includes an allyl group and which is curable by radical polymerization, there are examples described below, however, it is not limited to those described below.

There are methallyl ester including bromine not including an aromatic ring (see Japanese Patent Application Laid-Open Publication No. 2003-66201), allyl methacrylate (see Japanese Patent Application Laid-Open Publication No. H5-286896), allylic ester resin (see Japanese Patent Application Laid-Open Publication No. H5-286896, Japanese Patent Application Laid-Open Publication No. 2003-66201), copolymer compound of acrylic acid ester and undersaturated compound including epoxy group (see Japanese Patent Application Laid-Open Publication No. 2003-128725), acrylate compound (see Japanese Patent Application Laid-Open Publication No. 2003-147072), acrylic ester compound (see Japanese Patent Application Laid-Open Publication No. 2005-2064) or the like.

### (3) Epoxy Resin

The epoxy resin is not limited as long as the resin includes an epoxy group and is polymerically cured optically or thermally, and as the curing initiator, acid anhydride, cation generator or the like can be used. Since the epoxy resin has a low rate of shrinkage, it is preferable to form a lens with outstanding molding accuracy

As types of epoxy, there are, novolak phenol type epoxy resin, biphenyl type epoxy resin, and dicyclopentadiene type epoxy resin. As an example, there are bisphenol F diglycidyl ether, bisphenol A diglycidyl ether, 2,2′-bis(4-gycidyl oxy cyclohexyl)propane, 3,4-epoxy cyclohexyl methyl-3,4-epoxy cyclohexane carboxylate, vinyl cyclohexene dioxide, 2-(3,4-epoxy cyclohexyl)-5,5-spiro-(4-epoxy cyclohexane)-1,3-dioxane, bis(3,4-epoxy cyclohexyl)adipate, 1,2-cyclopropane dicarboxylic acid bis glycidyl ester, etc.

A curing agent is used to compose curable resin. material and is rot particularly limited. In the present invention, when the transmittance of the curable resin material is compared with that of the optical material after adding the additive agent, the curing agent does not include the additive agent. As the curing agent, an acid anhydride curing agent, phenol curing agent, etc. can be preferably used. As a specific example of the acid anhydride agent, there are, phthalic anhydride, maleic anhydride, trimellitic anhydride, pyromellitic dianhydride, hexahydrophthalic anhydride, 3-methyl-hexahydrophthalic anhydride, 4-methyl-hexahydrophthalic anhydride, or a mixture of 3-methyl-hexahydrophthalic anhydride and 4-methyl-hexahydrophthalic anhydride, tetrahydrophthalic anhydride, nadic acid anhydride, methyl nadic acid anhydride, and the like. A curing accelerator is included as necessary. The curing accelerator is not limited as long as the curing properties are preferable, there is no coloring, and the transparency of the thermal curable resin is not lost. For example, imidazole type such as 2-ethyl-4-methylimidazole (2E4MZ), etc., tertiary amine, quaternary ammonium salt, bicyclic amidine type and its derivative such as diazabicyclo undescene, etc., phosphine, phosphonium salt, etc. can be used, and one type of the above can be used or two or more types of the above can be mixed and used.

In the imaging lens 2, adhesive is applied between the non-lens portion 22b of the lens group 8 and the non-lens portion 32b of the lens group 10, and the lens group 8 and the lens group 10 are adhered. The non-lens portions 22b and 32b correspond to the flange portions of the concave lens portions 22a and 32a.

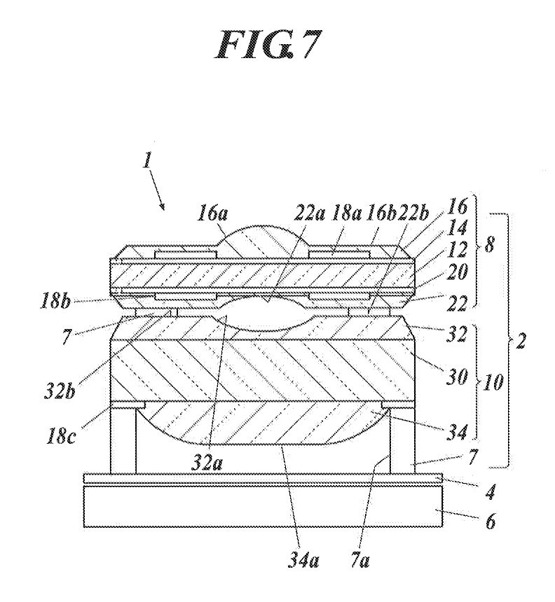

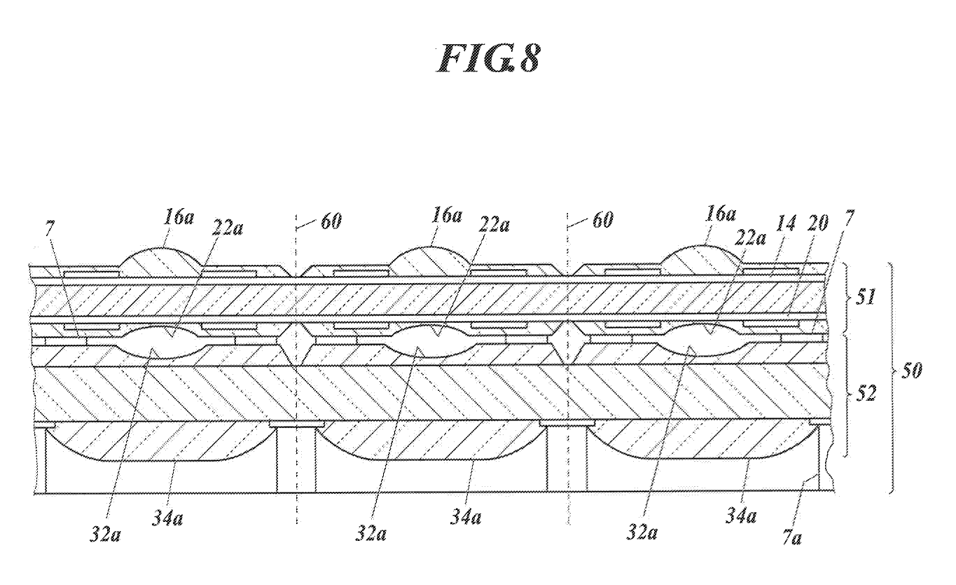

A spacer 7 is adhered to the lens group 10. An opening 7a is formed on the spacer 7. The lens group 8 and the lens group 10 are adhered with an adhesive. However, it is possible to provide a spacer 7 between the lens group 8 and the lens group 10 and to adhere the lens groups 8 and 10 through a spacer 7 as shown in, for example FIG. 7 and FIG. 8.

In the imaging lens 2, the surfaces of the convex lens portion 16a, the concave lens portion 22a, the concave lens portion. 32a, the convex portion 34a each have an aspheric shape and the optical axis match.

From the object side to the image side, the convex lens portion 16a composes a “S1 surface” which is the object side optical surface of the lens group 8, the concave lens portion 22a composes a “S2 surface” which is the image side optical surface of the lens group 8, the concave lens portion 32a composes a “S3 surface” which is the object side optical surface of the lens group 10, and the convex lens portion 34a. composes a “S4 surface” which is the image side optical surface of the lens group 10.

### [Method For Producing Imaging Apparatus (Imaging Lens)]

Next, the method for producing the imaging apparatus 1 (including the method for producing the imaging lens 2) is briefly described with reference to FIG. 1 to FIG. 3.

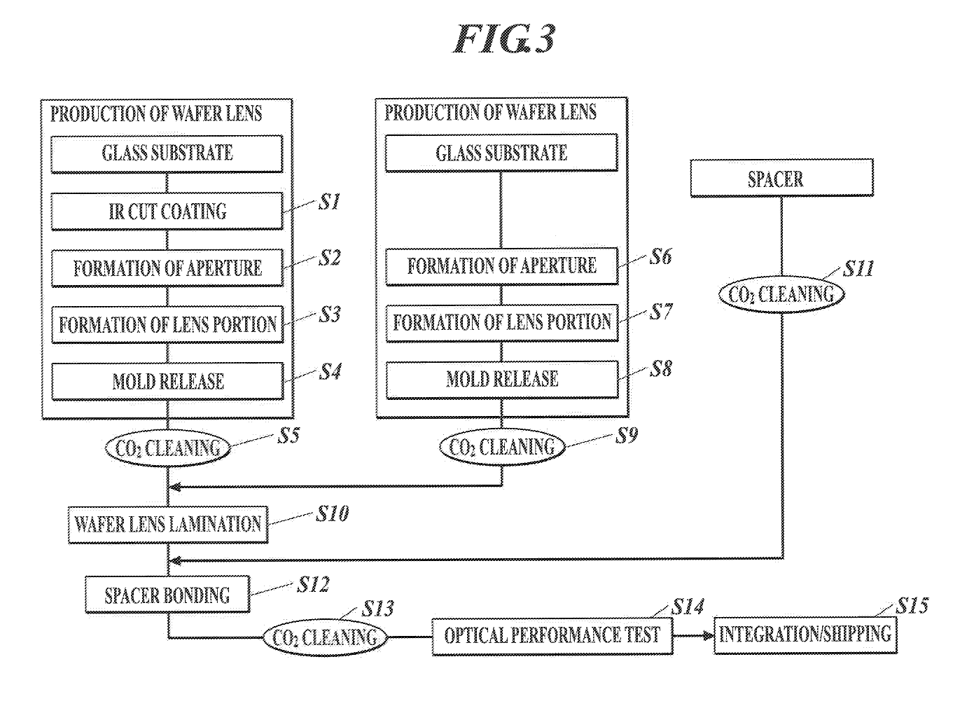

First, IR cut coatings 14 and 20 are formed on the glass substrate 12 (step S1 shown in FIG. 3). Well known vacuum deposition method, sputtering method, CVD (Chemical Vapor Deposition) method, are used to form IR cut coatings on each of the front surface and the rear surface of the glass substrate 12. The IR cut coating (infrared shielding film) is a film to cut infrared ray and has a transmittance of 50% or more of light with a wavelength of 365 nm. Here, the IR cut coatings 14 and 20 are divided into two layers to prevent warpage.

Next, for example, a light blocking photoresist is applied on the glass substrate 12 and the light blocking photoresist is patterned in a predetermined shape to form a plurality of apertures 18a (step S2). As the light blocking photoresist, a photoresist which mixes carbon black can be used.

Then, photo-curable resin is dropped on the mold or the glass substrate, one of the mold or the glass substrate 12 in the wafer shape is pressed to the other to fill photo-curable resin between the mold and the glass substrate 12 to emit light on the photo-curable resin and to cure the photo-curable resin. As a result, a plurality of convex lens portions 16a are formed on the glass substrate 12 (step S3). Here, when the photo-curable resin is specifically epoxy resin, since the response does not advance completely even when light is emitted, warpage of the glass substrate 12 rarely occurs when released from the mold. Here, as shown in FIG. 7 and FIG. 8, the above mold can be individual mold in which resin for the convex lens portion 16a and the concave lens portion 22a are dropped and molded individually.

After the lens portions 16a and 22a are formed, the mold is released from the glass substrate 12 (step S4). Release from the mold can be performed after forming the convex lens portion 16a and after forming the concave lens portion 22a. Alternatively, release can be performed at once after forming the lens portions 16a and 22a on both surfaces.

Then, after release, heating processing is performed on the lens portions 16a and 22a on both surfaces of the glass substrate 12 as post curing. Post curing can be performed at once on the lens portions 16a and 22a on both surfaces or can be performed on one lens portion at a time after releasing each of the lens portions 16a and 22a.

By such release, a wafer lens 51 including a plurality of lens portions 16a and 22a is produced.

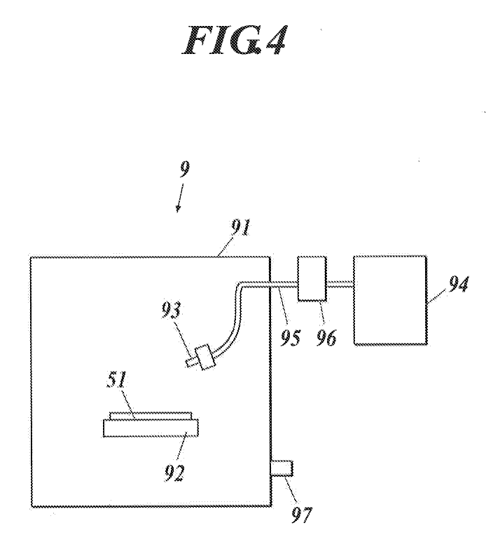

Then, carbon dioxide cleaning is performed on the lens portions 16a and 22a (first lens portion cleaning step: step S5). The carbon dioxide cleaning is performed using a later described carbon dioxide cleaning apparatus 9 (see FIG. 4). The liquid carbon dioxide is spouted to form dry ice particles A and by causing the dry ice particles to hit on the lens portions 16a and 22a, the dust attached to the lens portions 16a and 22a is removed. The specific method is described below.

Similar to producing the wafer lens 51, a plurality of apertures 18c, a plurality of concave lens portions 32a and convex lens portions 34a are formed on the glass substrate 30 and released (steps S6 to S8). As shown in FIG. 7 and FIG. 8, the mold for forming the concave lens portion 32a and convex lens portion 34a can be an individual mold in which resin is dropped and molded individually.

After release, post curing is performed. The IR cut coating does not have to be performed on the glass substrate 30.

Then, a reflection preventing film (not shown) is formed on the resin portion 34. The reflection preventing film includes a two layer configuration. A first layer is directly formed on the resin portion 34 and a second layer is formed on the first layer.

The first layer is a layer including high refractive index material with a refractive index of 1.7 or more, and preferably includes Ta2O5, a mixture of Ta2O5 and TiO2, ZrO2, or a mixture of ZrO2 and TiO2. The first layer can include TiO2, Nb2O3, and HfO2.

The second layer is a layer including low refractive index material with a refractive index of less than 1.7, and preferably includes SiO2. The carbon dioxide cleaning can be performed before forming the reflection preventing film.

The first layer and the second layer of the reflection preventing film are formed by a method such as vapor deposition. Preferably, the first layer and the second layer are formed maintaining the film forming temperature in a range of −40° to +40° (preferably −20° to) +20° with respect to melting temperature of a conductive paste such as soldering used in reflow processing.

In the present embodiment, a first layer and a second layer are further laminated alternately on the first layer and the second layer to make the reflection preventing film with a structure including a total of two to seven layers. In this case, the layer directly in contact with the resin portion can be a layer including high refractive index material (first layer) or a layer including low refractive index material (second layer) depending on the type of resin. Here, the layer directly in contact with the resin portion is to be a layer including high refractive index material.

Also, the reflection preventing film is formed only on the surface of the resin portion 34 and can be formed on all surfaces of the resin portions 16, 22, 32 and 34.

In order to prevent a ghost generated in the imaging element 6, it is effective to provide a reflection preventing film on the surface of the resin portion 34. In order to prevent the problem such as a crack generating in a boundary face between the reflection preventing film and the resin portion 34, it is preferable to provide the reflection preventing film only on the resin portion 34. In this case, the reflection preventing film is provided on a face closest to the imaging element 6.

By forming a reflection preventing film as described above, a wafer lens 52 including a plurality of lens portions 32a and 34a are produced.

After forming the reflection preventing film, carbon dioxide cleaning is performed similar to the above step S5 (first lens portion cleaning step: step S9).

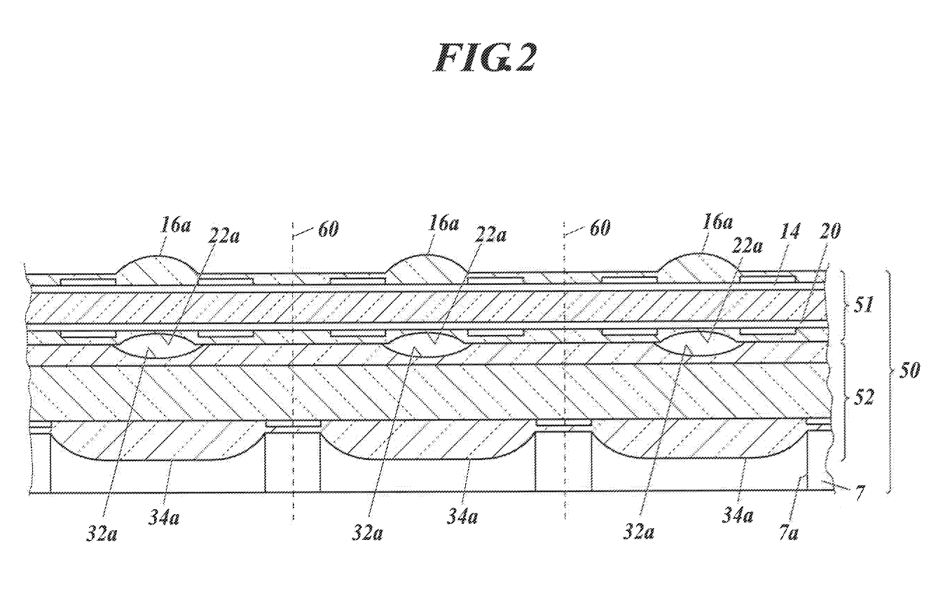

Then, adhesive is applied to at least one of the non lens portions 22b or 32b and the wafer lenses 51 and 52 are bonded to each other (step S10) (see FIG. 2),

Similar to step S5, the carbon dioxide cleaning is performed on the spacer 7 also (spacer cleaning step: step S11).

Adhesive is applied to at least one of the spacer 7 after cleaning and non-lens group 34b of the lens group 10 and the spacer 7 after cleaning and the lens group 10 are bonded to each other (step S12). The spacer 7 can be bonded directly to a single layer of a wafer lens without the lamination step (S10) between the wafer lenses.

As a result, the wafer lens laminated body 50 is produced (see FIG. 2).

Then, when shipped in a state of the wafer lens laminated body 50, although not shown in FIG. 3, an optical performance test is performed before shipment after performing the above carbon dioxide cleaning again on the wafer lens laminated body 50. Then, shipment is performed on merchandise in a state of the wafer lens laminated body.

When fragmented and shipped as the imaging lens 2, after bonding the spacer 7 and forming the wafer lens laminated body 50 a dicer is used to dice the wafer lens laminated body 50 at a dicing line 60 to fragment into each group including one set of the convex lens portion 16a, the concave lens portion 22a, the concave lens portion 32a, and the convex lens portion 34a as one unit as shown in FIG. 2

As a result, a plurality of imaging lenses 2 are produced.

When the resin portions 16, 22, 32, and 34 are diced, for example, it is preferable to dice by abrasive grain using a dicer using an endless blade (rotating blade) and the rotating number of the endless blade is 10,000 to 20,000 rpm.

When the resin portions 16, 22, 32, and 34 are diced, it is preferable to dice from the resin portion 16 on the object side toward the resin portion 34 on the image side. During the dicing, since dust flies in the dicing portion of the resin portions 16, 22, 32 and 34, it is preferable to dice while flowing (spraying) pure water to control the dust on the dicing portions.

In the present embodiment, after producing the imaging lens 2 by dicing, the cover glass 4 of the imaging element and the imaging element 6 are provided. However, the imaging apparatus 1 can be obtained by laminating the wafer lens laminated body 50 to a substrate provided with a plurality of imaging elements 6 and then dicing.

As an example of a producing method of the electronic device, when the imaging apparatus 1 and another electronic component are mounted on a printed circuit board, the imaging apparatus 1 and the electronic component can be mounted simultaneously on the printed circuit board by the following. A solder may be placed in advance on the printed circuit board, the imaging apparatus 1 and the electronic component may be placed on the printed circuit board, then the printed circuit board may be inserted and heated in the reflow furnace to melt the solder, and then cooled.

### [Carbon Dioxide Cleaning]

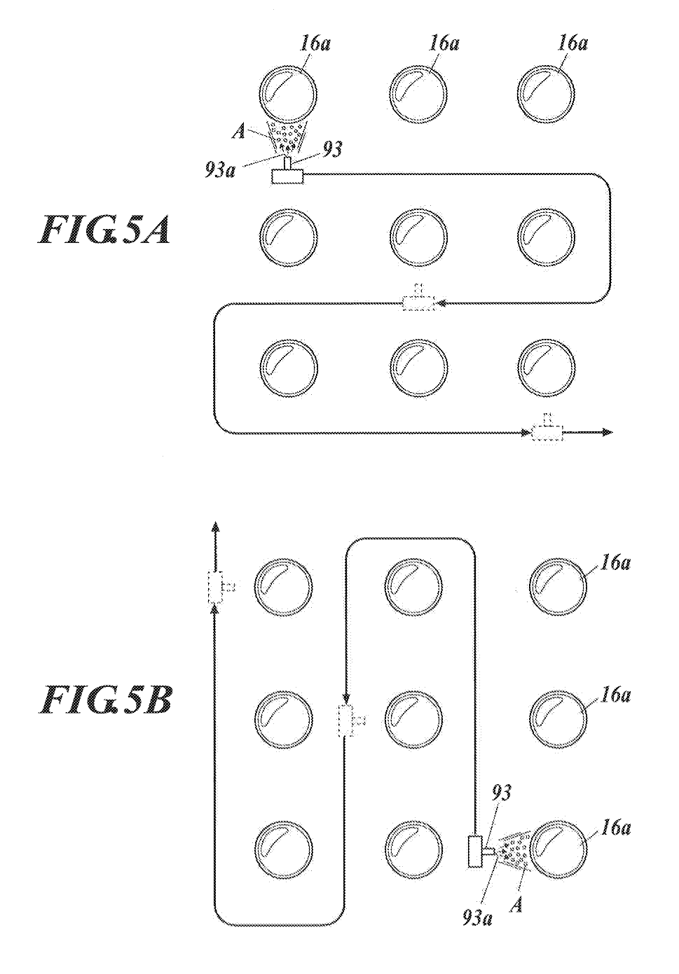

Next, the carbon dioxide cleaning on the wafer lens 51 in the above step S5 is described in detail with reference to FIG. 4 and FIG. 5.

FIG. 4 is a schematic diagram showing a carbon dioxide cleaning apparatus.

The carbon dioxide cleaning apparatus 9 including a cleaning room 91, a stage 92 which is provided in the cleaning room 91 and on which the wafer lens 51 is placed, a nozzle 93 which spouts liquid carbon dioxide and hits dry ice particles A on the wafer lens 51 placed on the stage 92, a carbon dioxide supply source 94 which supplies the liquid carbon dioxide to the nozzle 93, a duct 95 which connects the nozzle 93 and the carbon dioxide supply source 94, and a pressurizing apparatus 96 which is provided in the duct 95 and which pressurizes the liquid carbon dioxide to be spouted from the nozzle 93. A hole (not shown) is provided in the cleaning room 91 to supply N2 to control the dew point.

The cleaning room 91 is provided with an opening/closing hole (not shown) which can be sealed to place in and out the wafer lens 51, an exhaust hole 97 which exhausts gas (carbon dioxide gas, etc.) in the cleaning room 91, a filter which catches dust (not shown), neutralizing apparatus (not shown) and the like.

The nozzle 93 includes a configuration to be able to move along the lens portion 16a of the wafer lens 51. FIG. 5A and FIG. 5B are planar diagrams of the plurality of lens portions and the nozzle.

As shown in FIG. 5, the nozzle 93 moves between the lens portions 16a adjacent to each other and moves along the lens portions 16a aligned in the vertical direction and the lens portions 16a aligned in the horizontal direction.

Specifically, as shown in FIG. 5A, the nozzle moves in a winding serpentine shape from the upper left lens portion 16a to the lower right, lens portion 16a as shown in FIG. 5A, and then the nozzle 93 returns in a winding serpentine shape from the lower right lens portion 16a to the upper left lens portion 16b as shown in FIG. 5B. Here, in FIG. 5A, the direction of movement of the nozzle in the left and right row direction such as from upper left to upper right is to be the main scanning direction and in FIG. 5E, the direction of movement of the nozzle in the up and down column direction such as from lower right to upper right is to be the main scanning direction. The direction substantially perpendicular to the above is to be the sub-scanning direction.

In other words, as shown in FIG. 5A, the nozzle 93 is provided to aim between the lens portion. 16a of the first row and the lens portion 16a of the second row aligned in the horizontal direction. After moving along the right direction in a straight line, the nozzle 93 moves between the lens portion 16a of the second row and the lens portion 16a of the third row. After moving along the left direction in a straight line, the nozzle 93 circles to the outer side of the lens portion 16a of the third row and moves along the right direction in a straight line. Then, as shown in FIG. 5B, the nozzle 93 starts movement from the lens portion 16a on which the final cleaning shown in FIG. 5A is performed. The nozzle 93 is provided between the lens portion 16a of the first column and the lens portion 16a of the second column aligned in the vertical direction. After moving along the upper direction in a straight line, the nozzle 93 is positioned between the lens portion. 16a of the second column and the lens portion 16a of the third column. After moving along the lower direction in a straight line, the nozzle 93 circles to the outer side of the lens portion 16a of the third column and moves along the upper direction in a straight line. With such movement, the nozzle 93 returns to the position of the lens portion 16a when the cleaning starts as shown in FIG. 5A.

As described above, by moving a plurality of times in the horizontal direction and the vertical direction of the wafer lens 51 to perform cleaning, each lens portion or the entire vicinity of the lens portion is cleaned a plurality of times after a certain amount of time passes and dust can be securely removed, including dust which could not be removed by cleaning once. The lens portion is usually provided in a regular pattern such as in a grid and dust which cannot be removed by cleaning once is, for example, dust remaining in a position where dust cannot be removed such as a portion which is a shadow of the lens when the spouting direction of the nozzle 93 is in one direction, dust once removed but which attached to another lens portion, and the like. By using a certain amount of time for the cleaning process of one lens, dust which falls from the air from the other positions can be cleaned and time for moving to remove dust of the portions which is the shadow can be secured.

When spouting to the lens portion 16a in the first row of FIG. 5A, a spouting hole 93a of the nozzle 93 is provided so that the back faces the lens portion 16a side positioned in the second and third row on the downstream side of the moving direction instead of the spouting hole 93a of the nozzle 93.

When spouting to the lens portion 16a in the first column of FIG. 5B, the spouting hole 93a of the nozzle 93 is provided so that the back faces the lens portion 16a side positioned in the second and third column on the downstream side of the moving direction instead of the spouting hole 93a of the nozzle 93.

As described above, the nozzle hole 93a of the nozzle 93 is provided so that the back faces the lens potion 16a of the rows and columns on the downstream side and the dry ice particles A are spouted. Therefore, the lens portion 16a cooled by the hits from the dry ice particles A increases its temperature when further dry ice particles A are not spouted. However, when the dry ice particles A are hit against the lens portion 16a on the downstream side, some of the dry ice particles A are spouted. With this, the increase in temperature becomes gradual. As a result, the warpage of the lens portion 16a due to difference in temperature can be suppressed. In a wafer lens where glass and resin is laminated, linear expansion coefficient is different between the glass and the resin. Therefore, warpage due to difference in temperature easily occurs and it is important to keep the difference in temperature small.

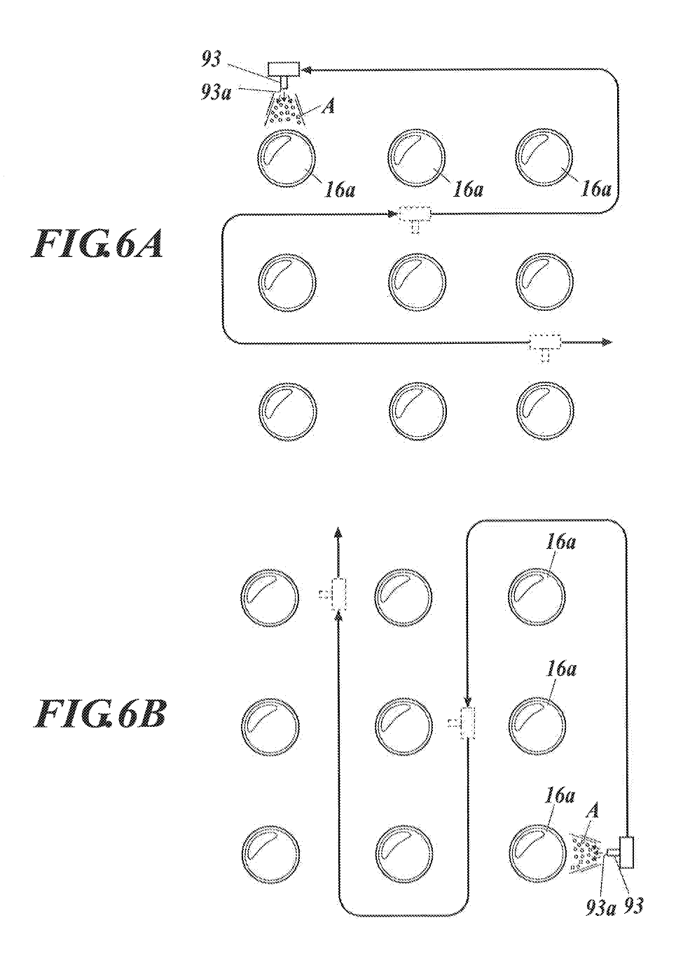

As shown in FIG. 6A and FIG. 6B, the spouting hole 93a of the nozzle 93 can be provided so as to be opposite from FIG. 5A and. FIG. 5B. Specifically, the spouting hole 93a of the nozzle 93 can be provided to face the lens portion 16a side of the rows and columns on the downstream side.

By providing the spouting hole 93a of the nozzle 93 in this way, in addition to cleaning the lens portion 16a, the cleaned dust can be moved simultaneously to the downstream side, and the dust scattering to the upstream side and the downstream side can be prevented.

Next, the operation of the carbon dioxide cleaning apparatus 9 is described.

First, the wafer lens 51 is placed on the stage 92. Here, the lens portions 16a and 22a are provided on both surfaces of the glass substrate 12. Therefore, it is preferable that the glass substrate 12 is placed to be lifted from the stage 92 so that the lens portion 22a facing the stage 92 side does not contact with the stage 91. Specifically, a plurality of pins (not shown) which support the glass substrate 12 on the stage 92 are provided, and the glass substrate 12 is supported on the pins,

Then, the inside of the cleaning room 91 is sealed and filled with nitrogen gas. With this, the inside of the cleaning room 91 is set so that the dew point is −40° or less.

Then, the pressurizing apparatus 96 is driven so that liquid carbon dioxide is flown from the carbon dioxide supply source 94 to the nozzle 93.

Then, the nozzle 93 is provided between adjacent lens portions 16a as described above and moved in a predetermined direction. It is preferable that the tilting angle to the lens portion 16a of the nozzle 93 is 20° to 50° with respect to the face orthogonal to the optical axis, and specifically it is preferable that the angle is 30° to 45°. Here, when the angle is 20° or less, the degree of density of carbon dioxide decreases and suitable cleaning cannot be performed When the angle is 50° or more, the angle is too steep and the dust is scattered and suitable cleaning cannot be performed.

The sent liquid carbon dioxide is formed to dry ice particles A and spouted from the spouting hole 93a of the nozzle 93. The spouted dry ice particles A are hit to the lens portion 16a of the wafer lens 51 at a predetermined angle and speed. The hit by the dry ice particles A separates the dust attached to the lens portion 16a from the lens portion 16a and removes the dust. The hit dry ice particles A are then sublimed to carbon dioxide gas in the cleaning room 91 and exhausted from the exhaust hole 97 after cleaning.

After cleaning of the wafer lens 51 ends, it is preferable to heat the wafer lens 51 with a heater (riot shown) before removing from the cleaning room 91 (heating process). By heating the wafer lens 51 cooled by cleaning, the warpage caused when taking the wafer lens 51 outside the cleaning room 91 can be prevented.

The above carbon dioxide cleaning can be similarly applied to the lens portion 22a and can be similarly applied to the carbon dioxide cleaning of steps S9, S10, S11 and S13.

In the above carbon dioxide cleaning apparatus 9, the nozzle 93 is moved to the lens portion 16a of the wafer lens 51. Alternatively, the wafer lens 51 side can be moved to the nozzle 93 to clean the lens portion 16a. In this case, the stage 92 can be made to be able to move.

The moving direction of the nozzle 93 is not limited as described in FIG. 4 and FIG. 5 and can be suitably modified.

As described above, according to the present embodiment, before lamination of the wafer lenses 51 and 52, the liquid carbon dioxide is spouted to form dry ice particles A and the dry ice particles A are hit to the lens portion 16a of the wafer lens 51 to clean the lens portion 16a. Therefore, the dust attached to the lens portion 16a can be securely and easily separated and removed. Therefore, the problem of the lens interval changing due to the dust does not occur and the deterioration of optical performance can be prevented.

Further, after the wafer lenses 51 and 52 are laminated, the spacer 7 on which carbon dioxide cleaning is performed is laminated and carbon dioxide cleaning is performed again. Therefore, the removal of dust can be securely performed and it is effective for preventing the deterioration of the optical performance.

The carbon dioxide cleaning is completely dry cleaning. Therefore, changes in optical performance due to moisture absorption of the lens portion caused by conventional water cleaning and separation of the resin from the substrate caused by ultrasonic cleaning can be prevented.

The configuration hits dry ice particles A from the nozzle 93 to each lens portion 16a. Therefore, the angle and the gas flow rate to the lens portion 16a of the nozzle 93 and the grain diameter and the density of the dry ice particles A can be easily adjusted. Consequently, cleaning is effectively performed.

### DESCRIPTION OF REFERENCE NUMERALS

1 imaging apparatus
2 imaging lens
4 cover glass of imaging element
6 imaging element
7 spacer
8, 10 lens group
9 carbon dioxide cleaning apparatus
12 glass substrate
14 IR cut coating
16 resin portion
16a convex lens portion
16b non-lens portion
18a, 18b, 18c aperture
20 IR cut coating
22 resin portion
22a concave lens portion
22b non-lens portion
30 glass substrate
32 resin portion
32a concave lens portion
32b non-lens portion
34 resin portion
34a convex lens portion
34b non-lens portion
50 wafer lens laminated body
51, 52 wafer lens
60 dicing line
91 cleaning room
92 stage
93 nozzle
93a spouting hole
94 carbon dioxide supplying source
95 duct
96 pressurizing apparatus
97 exhaust hole
A dry ice particles

1. A method for producing an imaging lens in which a plurality of layers including one or more wafer lenses each provided with a lens portion that is formed from a curable resin are laminated on at least one surface of a substrate, the method comprising:
before lamination of the plurality of layers including the wafer lenses, a first lens portion cleaning step wherein carbon dioxide cleaning of the lens portions is carried out by spouting carbon dioxide so as to form dry ice particles and by causing the dry ice particles to hit on the lens portions of the wafer lenses or the vicinities of the lens portions.

2. The method for producing an imaging lens of claim 1, wherein, at least one layer among the plurality of layers is a spacer on which the carbon dioxide cleaning is carried out,

3. The method for producing an image lens of claim 1, further comprising:
after the lamination of the plurality of layers, a second lens portion cleaning step wherein carbon dioxide cleaning of the lens portions of the wafer lens or the vicinities of the lens portions and a spacer is carried out.

4. The method for producing an imaging lens of claim 1, wherein:
the wafer lens includes a plurality of the lens portions; and
a step of the carbon dioxide cleaning is carried out by causing the dry ice particles to hit on the lens portions while relatively moving a nozzle spouting carbon dioxide along a row of the lens portions aligned in a horizontal direction and a column of the lens portions aligned in a vertical direction among the plurality of the lens portions, the step carried out two or more times; and
there is a certain period between the steps.

5. The method for producing an imaging lens of claim 4, wherein, among the plurality of times of repetition, at least one time of the carbon dioxide cleaning is carried out by causing the dry ice particles to hit from a different nozzle spouting direction.

6. The method for producing an imaging lens of claim 4, wherein, the nozzle is relatively moved by positioning in a position to aim between lens portions adjacent to each other.

7. The method for producing an imaging lens of claim 4, wherein, a spouting hole of the nozzle is positioned so as to be perpendicular to a main scanning direction among moving directions of the nozzle.

8. The method for producing an imaging lens of claim 4, wherein, a spouting hole of the nozzle is positioned so as to spout in a direction where a back is facing the lens portion of a column and row of a downstream side of a sub-scanning direction among moving directions of the nozzle.

9. The method for producing an imaging lens of claim 4, wherein, a spouting hole of the nozzle is positioned so as to spout in a direction facing the lens portion side of a column and row of a downstream side of a sub-scanning direction among moving directions of the nozzle.

10. The method for producing an imaging lens of claim 1, further comprising a heating step which heats the wafer lens on which the carbon dioxide cleaning is carried out.

11. A method for producing an imaging lens in which a plurality of layers including one or more wafer lenses each provided with a lens portion that is formed from a curable resin are laminated on at least one surface of a substrate, the method comprising:
before lamination of the plurality of layers including the wafer lenses, a first lens portion cleaning step wherein carbon dioxide cleaning of the lens portions is carried out by spouting carbon dioxide so as to form dry ice particles and by causing the dry ice particles to hit on the lens portions of the wafer lenses or the vicinities of the lens portions; and
after the lamination of the plurality of layers, a second lens portion cleaning step wherein carbon dioxide cleaning of the lens portions of the wafer lens or the vicinities of the lens portions and a spacer is carried out, wherein, at least one layer among the plurality of layers is a spacer on which the carbon dioxide cleaning is carried out.
